(19) United States
(12) Patent Application Publication
(10) Pub. No.: US 2010/0059448 A1
(43) Pub. Date: Mar. 11, 2010

(54) MAGNETIC PARTICLES FOR WATER PURIFICATION AND WATER TREATMENT METHOD EMPLOYING THE SAME

(75) Inventors: Shinetsu Fujieda, Kawasaki-Shi (JP); Tatsuoki Kono, Tokyo (JP); Shinji Murai, Sagamihara-Shi (JP); Taro Fukaya, Kawasaki-Shi (JP); Hideyuki Tsuji, Yokohama-Shi (JP); Akiko Suzuki, Tokyo (JP); Nobuyuki Ashikaga, Kawasaki-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: Kabushiki Kaisha Toshiba, Tokyo (JP)

(21) Appl. No.: 12/405,575

(22) Filed: Mar. 17, 2009

(30) Foreign Application Priority Data
Sep. 5, 2008 (JP) 2008-228680

(51) Int. Cl. C07F 15/02; C02F 1/48; B32B 5/16

(52) U.S. Cl. 210/695; 556/147; 428/402

(57) ABSTRACT

The present invention provides a water treatment composition capable of effectively adsorbing pollutants in water treatment. The composition can be rapidly separated by use of magnetic force, and hence is excellent in workability. The composition comprises magnetic particles for water purification, and is suitably used in water treatment for removing oils and the like in water. The magnetic particles are prepared by subjecting magnetic powder to surface treatment with a particular organometallic compound. The organometallic compound comprises a metal atom connected to an alkoxy group and an amphipathic organic group.

### CROSS-REFERENCE TO RELATED APPLICATION

This application is based upon and claims the benefit of priority from the prior Japanese Patent Application No. 2008-228680, filed on Sep. 5, 2008; the entire contents of which are incorporated herein by reference.

### BACKGROUND OF THE INVENTION

1. Field of the Invention

The present invention relates to functional particles for water purification and also to a water treatment method employing the same. These particles are capable of selectively adsorbing oils discharged into seas or rivers and/or pollutants contained in industrial or domestic wastewater. Accordingly, the water treatment method employing these particles can remove the pollutants from the wastewater and the like.

2. Background Art

Wastewater drained from factories, restaurants, house-holds and the like is liable to contain pollutants, particularly, oils such as mineral and vegetable oils, and is often discharged into seas or rivers to cause serious ecological problems. When the seas or rivers are polluted with a large amount of oils, the oils are generally enclosed by oil fences to be prevented from dispersing and then recovered. Further, the oils are often adsorbed, solidified and recovered by use of oil-gelling agents. However, if the rivers run fast or the seas are rough, it is difficult to adsorb and solidify the oils. Accordingly, in that case, the oils not caught and fixed are adrift in the form of oil slicks, which are finally washed up on the beaches to affect seriously seabirds and/or marine resources. As a result, the discharged oils give very unfavorable effects particularly to creatures living in the seas and on the seashores, and it is beyond measure how seriously the ecological system is damaged.

On the other hand, in a water purification system for treating wastewater containing a small amount of oils dispersed therein, the wastewater is generally filtrated through a filter to remove the oils. However, since the filter in the system is often clogged with the oils, it is necessary to exchange the filter frequently. Accordingly, it is a problem that considerable cost and time are required to maintain the system. Further, in the case where the wastewater contains a large amount of oils, the oils and the water may separate to form upper and lower layers, respectively. If such layered wastewater is directly filtrated, the filter is immediately clogged. In that case, it is therefore necessary to perform troublesome pretreatments. For example, inorganic adsorbents such as silica and pearlite or organic water purification agents comprising oleophilic polymers are spread on the wastewater before the filtration. However, it is difficult to collect and recover the spread polymers of organic adsorbents, and the inorganic adsorbents are generally poor in oil adsorbability. Further, there is a problem how to treat the adsorbed oils.

In order to solve the above problems of adsorbents, various attempts have been proposed. For example, JP-A H07-102238 (KOKAI) discloses an adsorbent polymer comprising hydrophilic blocks and oleophilic blocks. In a method employing the disclosed polymer, oils in water are adsorbed on the adsorbent polymer and then the polymer is collected to remove the oils from the water. However, in this method, it is laborious to separate the adsorbent polymer from the water. Further, there is also a problem that the polymer having adsorbed the oils is softened to lower workability.

Meanwhile, there is known a method employing magnetized adsorbent particles. In the method, oils in water are adsorbed on the particles and then the particles are separated from the water by use of magnetic force. For example, JP-A 2000-176306 (KOKAI) discloses a method in which magnetic particles having surfaces modified with stearic acid are used to adsorb oils in water and thereby to remove them from the water. However, since the magnetic particles in this method are beforehand subjected to surface treatment with lower molecular weight compounds such as stearic acid or silane coupling agents, there is high possibility that those compounds contaminate the water on the contrary to the purpose of water purification.

### SUMMARY OF THE INVENTION

The present invention in one embodiment resides in magnetic particles for water purification, comprising magnetic powder having a surface with which amphipathic groups are combined via metal atoms.

Also, the present invention in another embodiment resides in magnetic particles for water purification, prepared by subjecting magnetic powder to surface treatment with an organometallic compound comprising a metal atom connected to an alkoxy group and an amphipathic organic group.

Further, the present invention in still another embodiment resides in a preparation process of magnetic particles for water purification, wherein an organometallic compound comprising a metal atom connected to an alkoxy group and an amphipathic organic group is mixed with magnetic powder and then stirred so that the magnetic powder is subjected to surface treatment.

Still further, the present invention in yet another embodiment resides in a water treatment composition comprising the above magnetic particles for water purification.

Furthermore, the present invention in still yet another embodiment resides in a water treatment method comprising the steps of:

dispersing the above magnetic particles in water containing impurities, so that said impurities are adsorbed on the surfaces of said magnetic particles, and then collecting and recovering the magnetic particles having adsorbed the impurities by use of magnetic force.

According to the present invention, pollutants such as oils contained in water can be removed rapidly, efficiently and readily. Further, the magnetic particles used in the water treatment can be reclaimed by making them release the oils adsorbed thereon.

### BRIEF DESCRIPTION OF THE DRAWINGS

FIG. 1 shows a sectional view schematically illustrating an apparatus in which water can be treated with the magnetic particles for water purification according to the one embodiment.

FIG. 2 shows a sectional view schematically illustrating another apparatus in which water can be treated with the magnetic particles for water purification according to the another embodiment.

### DETAILED DESCRIPTION OF THE INVENTION

### Magnetic Particles for Water Purification

The water treatment composition according to the present invention comprises magnetic particles for water purification. The magnetic particles for water purification comprise magnetic powder subjected to surface treatment with a particular organometallic compound. The particular organo-metallic compound comprises a metal atom connected to an alkoxy group and an amphipathic organic group.

Here, the “amphipathic organic group” means an organic group comprising an oleophilic moiety and a hydrophilic moiety in combination. The oleophilic moiety of the amphipathic group has a function of combining with impurities in water, namely, of adsorbing the impurities such as oils. On the other hand, the hydrophilic moiety ensures high dispersion stability of the particles.

In the present invention, the oleophilic moiety, namely, the hydrophobic group is generally a hydrocarbon chain, which may be either an aliphatic hydrocarbon chain or an aromatic one. This oleophilic group is preferably such a long hydro-carbon chain that the resultant magnetic particles can adsorb oils efficiently. In contrast, the hydrophilic moiety is a group of relatively high polarity, and is generally an acidic or basic residue.

Examples of the amphipathic group include acylate groups (—OCOR′: R′ is a hydrocarbon group), ammonium groups (—N⁺R¹R²R³: each of R¹ to R³ is hydrogen or a hydrocarbon group provided that at least one of them is a hydrocarbon group), carboxylate groups (RCOO—N⁺HR⁴R⁵: R is a hydrocarbon group and each of R⁴ and R⁵ is hydrogen or a hydrocarbon group), and hydrocarbon groups combined with carboxyls, hydroxyls, sulfonic acid groups or phosphoric acid groups.

As described above, the amphipathic group in the present invention is preferably a hydrocarbon chain connected to a hydrophilic group. There is no particular restriction on the position where the hydrophilic group is connected. However, the hydrophilic group is preferably placed near a granule of the magnetic powder when the organometallic compound is combined with the powder. If the resultant magnetic particles individually having that structure are dispersed in raw water, impurities in the water can be caught by the hydrophobic moieties extended from granules of the magnetic powder while the hydrophilic groups positioned near the granules can keep the particles dispersed stably in the water.

The metal atom contained in the organometallic compound contributes to performance of the magnetic particles for water purification. The magnetic powder used in the present invention may consist of powdery granules in various shapes, as described later. If the granules have some bulky shapes, there are voids in the magnetic powder. In that case, the resultant magnetic particles for water purification are liable to float on water and hence are often insufficiently dispersed. Even so, however, if the organometallic compound comprises a particular metal atom, the magnetic particles can have improved dispersability. Further, since the magnetic particles are spread in water to treat, the metal atom is preferably harmless in consideration of environmental load. Preferred examples of the metal atom contained in the organometallic compound include Zr, Al, Ti, Fe, Co, Ni, Cu and Zn. Among them, Zr, Al, Ti and Fe are particularly preferred.

The alkoxy group in the organometallic compound serves as a linking group combining the amphipathic organic group with the magnetic powder. It is presumed that the oxygen atom in the alkoxy group forms a linking structure of —O— when the alkoxy group attaches onto the surface of the magnetic powder. The magnetic powder is thus surface-treated with the organometallic compound, so that they are combined with the amphipathic group via the metal atom, to prepare the magnetic particles for water purification.

The organometallic compound is preferably a metal acylate compound represented by the following formula (I):

(RO)ₘM(OCOR′)ₙ (I).

In the formula,

M is a metal element selected from the group consisting of Zr, Al, Ti, Fe, Co, Ni, Cu and Zn, preferably, of Zr, Al, Ti and Fe;

each of m and n is independently an integer of 1 or more provided that the number of m+n corresponds to the valence of M;

R is an organic group containing 1 to 8 carbon atoms, and in the case of m is two or more, the plural groups of R may be the same or different from each other; and

R′ is a hydrocarbon group containing 1 to 30, preferably, 6 to 22 carbon atoms, and in the case of n is two or more, the plural groups of R′ may be the same or different from each other.

If R in the above formula is hydrogen, the compound is not only unstable at room temperature but also so basic that it may corrode the magnetic powder. It is, therefore, unfavorable.

The above metal acylate compound can be synthesized by any method. For example, it can be obtained by reacting hydroxyl of a metal alkoxide with a long chain carboxylic acid compound, an acid anhydride or an inorganic acid. Examples of the metal alkoxide include tetraisopropoxy titanate, tetra n-butoxy titanate, tetraisopropoxy zirconium, tetra n-butoxy zirconium, triisopropoxy aluminum, and tri n-butoxy aluminum. Examples of the acids reactable with the metal alkoxide include higher fatty acids such as caprylic acid, capric acid, lauric acid, myristic acid, palmitic acid, palmitoleic acid, stearic acid, oleic acid, linoleic acid, linolenic acid, ricinolic acid, arachic acid, icosenoic acid, behenic acid, and isomers thereof.

The organometallic compounds synthesized from the above may be used singly or in combination of two or more kinds. Further, crosslinking compounds and/or polymers can be incorporated so as to improve sizes and mechanical properties of the magnetic particles for water purification. Those optional components are preferably used since they make it possible to adopt a process at a higher temperature in preparing the composition or in performing water treatment with the magnetic particles for water purification.

The organometallic compound used for surface treatment in the present invention is preferably so insoluble in water that it can be firmly combined with the surface of the magnetic powder and that the treated powder can remain granular even in water.

For subjecting the magnetic powder to surface treatment with the organometallic compound, they are generally mixed and stirred. For example,

(1) a predetermined amount of a resin binder is dropped into or sprayed onto a mixture of the magnetic powder and the organometallic compound while the mixture is being vigorously stirred in a mixer; or

(2) the magnetic powder is beforehand mixed with a resin binder, so that the binder is attached on the surface of the powder, and then the organometallic compound is added to prepare a mixture, which is finally heated so that the compound can be fixed on the powder; or otherwise

(3) the magnetic powder, the organometallic compound and a resin binder are homogeneously mixed by means of, for example, three-roll mixing machine, ball mill, smash-mixing machine, homogenizer, planetary mixer, multipurpose mixer, extruder or Henschel mixer, to prepare a mixture, which is then granulated.

In one of the preferred methods, first the magnetic powder is placed in a mixer and rapidly stirred. The organo-metallic compound is then dropped into or sprayed onto the stirred powder to treat the surface of the powder. Successively, the surface-treated magnetic powder is subjected to heating treatment, so that the organometallic compound is fixed on the surface of the powder, to obtain the magnetic particles of the present invention for water purification. The heating treatment is carried out at a temperature of generally 200° C. or less, preferably 150° C. or less. If the temperature is too high, the organic group is often severed to lower the water purification performance. Accordingly, it is necessary to be careful that the temperature does not elevate too high.

The thus-prepared magnetic particles for water purification may slightly contain the organometallic compound and the magnetic powder in uncombined forms. However, it is possible to reduce the amount of the free compound and powder by controlling the conditions and the like.

The magnetic powder used in the present invention is not particularly restricted as long as it is made of magnetic substances. The magnetic substances are preferably materials exhibiting ferromagnetism at room temperature, but they by no means restrict embodiments of the present invention. Accordingly, any ferromagnetic material can be employed. Examples of the ferromagnetic material include iron, iron alloy, magnetite, ilmenite, pyrrhotite, magnesia ferrite, cobalt ferrite, nickel ferrite, and barium ferrite. Among them, ferrites having excellent stability in water are preferred because the object of the present invention can be effectively achieved. For example, magnetite (Fe₃O₄) is not only inexpensive but also stable in water, and further does not contain harmful elements. That is, hence, advantageously used for water treatment. The magnetic powder may consist of powdery granules in various shapes such as spheres, polyhedrons and irregular forms, but there is no particular restriction on the granule shapes. The sizes and shapes of the granules can be properly selected in consideration of production cost and other conditions. However, the shapes of the granules are preferably spheres or poly-hedrons having round corners. The powdery magnetic granules may be subjected to plating treatment such as Cu plating or Ni plating, if necessary.

There is no particular restriction on the mean size of the magnetic particles for water purification. The sizes and shapes of the magnetic particles can be controlled according to the treatment process, and the mean size is preferably 0.2 μm to 5 mm, more preferably 10 μm to 2 mm. In consideration of efficiency in recovering the particles, the mean particle size is preferably not less than 12 μm, more preferably not less than 20 μm. Here, the mean size of the magnetic particles for water purification can be determined by laser diffraction. For example, it can be measured by means of a measurement unit SALD-DS21 ([trademark], available from Shimadzu Corp.).

In the present invention, the magnetic powder does not need to consist of only the magnetic substances. For example, it may comprise very fine magnetic substance grains combined with a binder such as a resin. Further, the magnetic powder may comprise magnetic granules having surfaces subjected to hydrophobic treatment with alkoxysilane compounds such as methyltrimethoxysilane, methyltriethoxysilane, phenyltrimethoxysilane and phenyltriethoxysilane. It is only required of the magnetic powder that the resultant magnetic particles for water purification contain enough magnetic substances to be collected and recovered by use of magnetic force in the water treatment described later.

In the case where the magnetic powder comprises very fine magnetic substance grains, the sizes of the grains depend upon density of the powder and other various conditions, as well as, upon magnetic force given by the processing apparatus, flow rate and adsorbing method. However, the mean size of the fine magnetic substance grains is preferably in the range of 0.05 to 100 μm, and it can be determined by the aforementioned laser diffraction. If the mean grain size is more than 100 μm, the grains precipitate so rapidly that they are liable to disperse insufficiently. Further, those large grains have such small specific surface areas as to lower efficiency of adsorbing oils. It is, therefore, unfavorable. On the other hand, if the mean grain size is less than 0.05 μm, the primary grains often aggregate and float on raw water to lower the dispersability. Accordingly, it is also unfavorable.

Even in the case where the fine magnetic substance grains having relatively small sizes are combined with an organic or inorganic binder to form granules of the magnetic powder, the aforementioned organometallic compound can be used for surface treatment of the magnetic powder. In this case, the binder preferably contains hydroxyl in its structural chain since the organometallic compound having an alkoxy group easily undergoes a cross-linking reaction with it. Examples of the binder include organic binders such as polyviny acetal resins, polyvinyl alcohol resins, polyester resins, phenol resins, vinyl acetate resins, epoxy resins, phenoxy resins, and silicone resins. In the present invention, the resin binder combines the fine magnetic substance grains with each other to enlarge granules of the magnetic powder. There is no particular restriction on the resin binder except that it is soluble in a solvent giving no unfavorable effect to the organometallic compound and to the magnetic powder and that it solidifies to combine the fine grains with each other after the solvent is removed or after the reaction is completed. However, in the present invention, after the magnetic particles for water purification are used to remove oils from raw water, they are washed to release the adsorbed pollutants and thereby to be reclaimed. Accordingly, the resin binder is preferably insoluble in washing solvents or oil extraction solvents (described later) employed for washing the used magnetic particles. In consideration of these conditions, the most preferred resin binder is a polyviny acetal resin. Examples of the polyviny acetal resin include polyvinyl butyral resins, polyvinyl formal resins, polyviny acetoacetal resins, polyvinyl propianal resins, and polyvinyl hexylal resins. Among them, polyvinyl butyral resins are particularly preferred in view of water resistance and adhesion. The polyvinyl butyral resins are polymers obtained by adding butyl aldehyde to polyvinyl alcohol in the presence of acid catalyst. The polyvinyl butyral resins may have any molecular weight, and may be copolymerized with vinyl acetate or vinyl alcohol.

Various polyvinyl butyral resins are commercially available. Examples of them include S-LEC BL-1, BL-1H, BL-2, BL-5, BL-10, BL-S, BL-SH, BX-10, BX-L, BM-1, BM-2, BM-5, BM-S, BM-SH, BH-3, BH-6, BH-S, BX-1, BX-3, BX-5, KS-10, KS-1, KS-3 and KS-5 (which are all trademarks and available from Sekisui Chemical Co., Ltd.). From them, the resin binder can be properly selected in view of adhesion and compatibility with the solvent.

The binder may be an inorganic substance such as an alkoxysilane compound, a polymer of alkoxysilane compound or water glass. From them, the binder can be properly selected in view of mechanical strength, water resistance, and reactivity with the organometallic compound.

The shapes of the resultant magnetic particles for water purification can be adequately selected in consideration of dispersability in water, insolubility, mechanical strength, and damage of the ecological system if the particles should be discharged. Examples of the shapes include spheres, pseudo-spheres, porous shapes, fibers, sheets and strings. The particles can be formed into various shapes in consideration of workability, method of recovering the particles, and method of removing oils.

The water treatment composition according to the present invention comprises the aforementioned magnetic particles for water purification, and further may contain various additives, if necessary. For example, an oil-absorbent inorganic compound may be incorporated so as to further improve oil-adsorbability. The oil-absorbent inorganic compound is preferably filler of fine silica particles having a mean size of 40 nm or less. Examples of the filler include Aerosil 130, Aerosil 200, Aerosil 200V, Aerosil 200CF, Aerosil 200FAD, Aerosil 300, Aerosil 300CF, Aerosil 380, Aerosil R972, Aerosil R972V, Aerosil R972CF, Aerosil R974, Aerosil R202, Aerosil R805, Aerosil R812, Aerosil R812S, Aerosil OX50, Aerosil TT600, Aerosil MOX80, Aerosil MOX170, Aerosil COK84, Aerosil RX200, and Aerosil RY200 (which are all trademarks and available from Evonik Degussa Japan). Among them, preferred are oleophilic silica particles excellent in ability to purify water.

Further, it is also possible to use fibrous filler in combination. Examples of the fibrous inorganic filler include whiskers of titania, aluminum borate, silicon carbide, silicon nitride, potassium titanate, basic magnesium, zinc oxide, graphite, magnesia, calcium sulfate, magnesium borate, titanium diboride, a-alumina, chrysotile and wallastnite; amorphous fibers such as E-glass fibers, silica alumina fibers and silica glass fibers; and crystalline fibers such as tirano fibers, silicon carbide fibers, zirconia fibers, γ-alumina fibers, α-alumina fibers, PAN-based carbide fibers and pitch-based carbon fibers.

### Water Treatment Method

The water treatment method according to the present invention is used for separating pollutants from raw water containing them. Here, the “pollutants” means substances that are contained in raw water to treat and that must be removed so as to reuse the water. The water treatment composition according to the present invention is preferably employed for treating raw water containing organic pollutants, particularly, oils in consideration of adsorbability, of ability to keep the particle shapes after the pollutants are adsorbed thereon, and of the process for recovering the composition having adsorbed the pollutants. Here, the “oils” means oils and fats that are generally liquid at room temperature, that are only slightly soluble in water, that have relatively high viscosities and that have specific gravities lower than water. They are, for example, mineral oils, animal and vegetable fats and oils, hydrocarbons, and aromatic oils. Those oils are characterized by functional groups contained therein, and hence the organometallic compound employed for preparing the magnetic particles for water purification is preferably selected in accordance with the functional groups.

In the water treatment method according to the present invention, first the aforementioned water treatment composition is dispersed in raw water containing the oil pollutants described above. Since the surfaces of the magnetic particles have affinity to the pollutants, the pollutants are adsorbed on the particles. The magnetic particles of the present invention have oleophilic groups loaded on their surfaces, and hence they adsorb the pollutants very efficiently. Accordingly, the adsorption ratio of the magnetic particles is very high although it depends upon the concentration of the pollutants and upon the amount and surface area of the particles. If the magnetic particles for water purification are spread in a sufficient amount, the pollutants are adsorbed in an amount of generally 80% or more, preferably 97% or more, more preferably 98% or more, most preferably 99% or more.

After the pollutants are adsorbed, the magnetic particles for water purification are collected and recovered to remove the pollutants from the water. In this step, magnetic force is used to collect the particles. Since the magnetic particles for water purification are attracted by magnetic force, they can be easily collected and recovered. In combination with the magnetic force, sedimentation by gravity or centrifugal force in a cyclone can be used to separate the particles. The separation in this combination can improve workability, so that the pollutants can be rapidly recovered.

There is no particular restriction on the water to treat. The water treatment method according to the present invention can be practically applied to industrial wastewater, sewage, and domestic wastewater. There is also no particular restriction on the concentration of pollutants in the water. However, if the pollutants are too thickly contained, it is necessary to use a large amount of the magnetic particles. Accordingly, in that case, it is preferred to lower the concentration of pollutants by other methods before the water treatment so that the magnetic particles can work effectively.

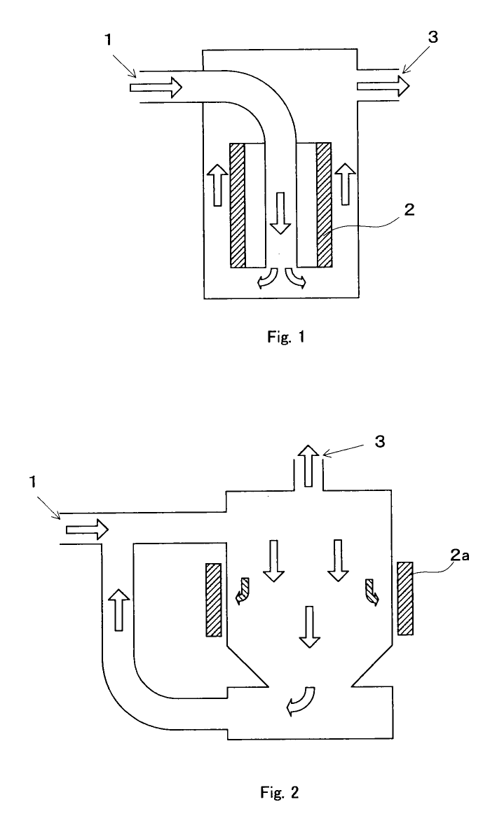

The water treatment method according to the present invention can be performed, for example, in an apparatus shown in FIG. 1 or 2. The apparatus of FIG. 1 is suitable for relatively small-scale water treatment, and is preferably used for treating a small amount of raw water such as domestic wastewater. In the apparatus of FIG. 1, waste water introduced from the inlet 1 is led to flow through the pipe surrounded by the magnet 2, and then drained from the outlet 3. The water treatment composition of the present invention is added before the waste water is introduced from the inlet 1. The oils in the waste water are adsorbed on the magnetic particles for water purification, and the particles having adsorbed the oils are accumulated on the inner wall of the pipe surrounded by the magnet 2. Thereafter, the accumulated particles are collected and recovered.

On the other hand, the apparatus of FIG. 2 is suitable for large-scale water treatment, and is effectively used for treating a large amount of waste water discharged from factories or for removing oils spilled into seas from tankers running aground. In the same manner as described above, the waste water is mixed with the water treatment composition according to the present invention and then introduced from the inlet 1, so that the oils in the waste water are adsorbed on the magnetic particles for water purification. The particles having adsorbed the oils are dispersed in the water, and then are collected with a superconductive magnet 2a placed near the tank. The collected particles are then removed, and the treated water is drained from the outlet 3.

In the above apparatuses, the magnetic particles having adsorbed the oils are collected and captured by a magnet. Accordingly, for the purpose of enhancing the processing capacity, a magnet in the form of a net or grid can be installed in the pipe to catch the magnetic particles for water purification.

In order to recover the oils, the magnetic particles having adsorbed the oils can be taken out of the pipe or tank and then washed with oil extraction (or washing) solvents such as n-hexane and alcohols. The magnetic particles for water purification can be thus made to release the adsorbed pollutants, so that they can be reclaimed.

The recovering apparatuses may be built in water treatment plants. Further, they may be modified to be mobile so as to cope with water treatment at the scenes of oil-spill accidents, such as, at the seas and rivers. The mobile recovering apparatuses can be loaded on water treatment vessels.

After the water treatment, the recovered magnetic particles for water purification can be reclaimed and reused. In order to reclaim the magnetic particles, it is necessary to remove the adsorbed pollutants from the particles. For removing the pollutants, the particles are preferably washed with oil extraction (or washing) solvents. The solvents preferably dissolve neither the organometallic compound nor the resin binder, but they preferably dissolve the adsorbed pollutants. Examples of the solvents include methanol, ethanol, n-propanol, iso-propanol, acetone, tetrahydrofuran, n-hexane, cyclohexane, and mixtures thereof. Further, other solvents can be also used according to the pollutants.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

### EXAMPLES

### Example 1

Magnetic powder of spherical ferrite granules (mean granule size: 0.79 μm, strength of magnetism: 84.4 emu/g) in the amount of 100 g was placed in a mixer. While the magnetic powder was being stirred at 12600 rpm, 2 g of zirconium tri-butoxymonostearate was dropped and sprayed therein. After stirred vigorously for 5 minutes, the mixture was heated at 100° C. for 20 hours in an oven to prepare functional particles for water purification.

### Example 2

Magnetic powder of spherical ferrite granules (mean granule size: 0.79 μm, strength of magnetism: 84.4 emu/g) in the amount of 100 g was placed in a mixer. While the magnetic powder was being stirred at 15700 rpm, 1 g of zirconium tri-butoxymonostearate was dropped and sprayed therein. After stirred vigorously for 5 minutes, the mixture was heated at 100° C. for 20 hours in an oven to prepare functional particles for water purification.

### Example 3

Magnetic powder of spherical ferrite granules (mean granule size: 0.79 μm, strength of magnetism: 84.4 emu/g) in the amount of 100 g was placed in a mixer. While the magnetic powder was being stirred at 15700 rpm, 0.5 g of zirconium tri-butoxymonostearate was dropped and sprayed therein. After stirred vigorously for 5 minutes, the mixture was heated at 100° C. for 20 hours in an oven to prepare functional particles for water purification.

### Example 4

Magnetic powder of spherical ferrite granules (mean granule size: 0.79 μm, strength of magnetism: 84.4 emu/g) in the amount of 100 g was placed in a mixer. While the magnetic powder was being stirred at 15700 rpm, 0.5 g of titanium tri n-butoxystearate was dropped and sprayed therein. After stirred vigorously for 5 minutes, the mixture was heated at 100° C. for 20 hours in an oven to prepare functional particles for water purification.

### Example 5

Magnetic powder of spherical ferrite granules (mean granule size: 0.79 μm, strength of magnetism: 84.4 emu/g) in the amount of 100 g was placed in a mixer. While the magnetic powder was being stirred at 15700 rpm, 0.5 g of aluminum diisopropylatemonostearate was dropped and sprayed therein. After stirred vigorously for 5 minutes, the mixture was heated at 100° C. for 20 hours in an oven to prepare functional particles for water purification.

### Example 6

Magnetic powder of spherical ferrite granules (mean granule size: 0.79 μm, strength of magnetism: 84.4 emu/g) in the amount of 100 g was placed in a mixer. While the magnetic powder was being stirred at 15700 rpm, 0.5 g of polyhydroxy-titanium stearate was dropped and sprayed therein. After stirred vigorously for 5 minutes, the mixture was heated at 100° C. for 20 hours in an oven to prepare functional particles for water purification.

### Example 7

Magnetic powder of spherical ferrite granules (mean granule size: 0.79 μm, strength of magnetism: 84.4 emu/g) in the amount of 100 g was placed in a mixer. While the magnetic powder was being stirred at 15700 rpm, 0.5 g of cyclic aluminum oxide isopropylate was dropped and sprayed therein. After stirred vigorously for 52 minutes, the mixture was heated at 100° C. for 20 hours in an oven to prepare functional particles for water purification.

### Example 8

Magnetic powder of spherical ferrite granules (mean granule size: 0.79 μm, strength of magnetism: 84.4 emu/g) in the amount of 100 g was placed in a mixer. While the magnetic powder was being stirred at 15700 rpm, 0.5 g of cyclic aluminum oxide stearate was dropped and sprayed therein. After stirred vigorously for 5 minutes, the mixture was heated at 100° C. for 20 hours in an oven to prepare functional particles for water purification.

### Comparative Examples 1 to 3

As comparative oil-adsorbent particles, commercially available oil-gelling agents of styrene-butadiene copolymer granules (Table 1B) having mean granule sizes of 200, 780 and 920 μm were prepared and directly evaluated.

TABLE 1A

| | | | Ratio to |
|---|---|---|---|
| | | Content | magnetic |
| | Organometallic compound | (wt. %) | powder (wt. %) |
| Ex. 1 | Zirconium tributoxymonostearate | 81 | 2.0 |
| Ex. 2 | Zirconium tributoxymonostearate | 81 | 1.0 |
| Ex. 3 | Zirconium tributoxymonostearate | 81 | 0.5 |
| Ex. 4 | Titanium tri n-butoxystearate | 86 | 0.5 |
| Ex. 5 | Polyhydroxytitanium stearate | 98 | 0.5 |
| Ex. 6 | Aluminum diisopropylatemonostearate | 75 | 0.5 |
| Ex. 7 | Cyclic aluminum oxide isopropylate | 45 | 0.5 |
| Ex. 8 | Cyclic aluminum oxide stearate | 70 | 0.5 |

TABLE 1B

| | | Mean size |
|---|---|---|
| | Oil-gelling agent | (μm) |
| Com. 1 | Styrene-butadiene copolymer | 200 |
| Com. 2 | Styrene-butadiene copolymer | 780 |
| Com. 3 | Styrene-butadiene copolymer | 920 |

### Evaluation of Oil-Adsorbent Particles

The oil-adsorbent particles prepared in Examples 1 to 8 and Comparative Examples 1 to 3 were evaluated in the following manners.

### (1) Adsorbability of Particles for Water Purification

A predetermined mineral oil in the amount of 50 μL, 100 μm, 110 μm or 120 μm was added and dispersed in 20 mL of pure water. The obtained dispersion and 0.1 g of the particles for water purification were mixed homogeneously by means of a shaker for 5 minutes, and then the particles were recovered by a magnet. Thereafter, the recovered particles and n-hexane (oil extraction solvent) were mixed to dissolve and extract the oil completely. The content of the oil extracted and dissolved in the n-hexane solution was analyzed by a gas-chromatography mass spectrometer (GC-MS), and thereby the oil-adsorbent ratio was calculated.

### (2) Mean Particle Size

The mean size of the particles was measured by laser diffraction. Before the measurement, a surfactant as a disperse medium was dropped to the particles, which were then dispersed ultrasonically. The mean size of thus dispersed particles was measured by means of SALD-DS21 ([trademark], available from Shimadzu Corp.).

### (3) Condition of Particles in Purifying Water

In the above (1), the oil-adsorbent particles homogeneously mixed with the oil dispersion were observed by eye to check the condition thereof.

### (4) Durability to Oil Extraction Solvent

When treated with the oil extraction solvent in the above (1), the oil-adsorbent particles immersed in the solvent were observed by eye to check the condition thereof.

### (5) Recoverability of Particles by Magnet

In the above (1), the magnet was brought close to a container in which the oil dispersion and the particles were mixed homogeneously, and thereby it was confirmed by eye whether the particles having adsorbed the oil could be gathered by the magnet or not.

TABLE 2
Adsorbability of particles

Amount of added oil (μm)

| | 50 | 100 | 110 | 120 |
|---|---|---|---|---|
| Ex. 1 | 99.84 | 99.68 | 99.15 | 98.54 |
| Ex. 2 | 99.72 | 99.53 | 98.32 | 98.45 |
| Ex. 3 | 99.87 | 99.59 | 98.25 | 95.26 |
| Ex. 4 | 99.99 | 99.92 | 99.58 | 99.12 |
| Ex. 5 | 99.82 | 97.83 | 95.21 | 95.20 |
| Ex. 6 | 98.81 | 95.95 | 95.24 | 94.26 |
| Ex. 7 | 96.43 | 95.10 | 95.17 | 95.14 |
| Ex. 8 | 95.74 | 95.31 | 93.23 | 90.30 |
| Com. 1 | 81.13 | 70.08 | 65.24 | 46.40 |
| Com. 2 | 85.82 | 65.10 | 61.51 | 24.00 |
| Com. 3 | 76.59 | 64.12 | 54.87 | 21.40 |

oil-adsorbent ratio (in terms of %)

TABLE 3

| | | Condition | Durability to | |
|---|---|---|---|---|
| | Mean size | of particles | oil extraction | Recoverability |
| | (μm) | having adsorbed oil | solvent | by magnet |
| Ex. 1 | 1.4 | good | not changed | good |
| Ex. 2 | 1.3 | good | not changed | good |
| Ex. 3 | 1.5 | good | not changed | good |
| Ex. 4 | 1.5 | good | not changed | good |
| Ex. 5 | 1.5 | good | not changed | good |
| Ex. 6 | 3.1 | good | not changed | good |
| Ex. 7 | 6.8 | good | not changed | good |
| Ex. 8 | 5.5 | good | not changed | good |
| Com. 1 | 200 | poor* | swollen | impossible |
| Com. 2 | 780 | poor* | swollen | impossible |
| Com. 3 | 920 | poor* | swollen | impossible |

*The particles cohered and attached on the inner wall in a mass.

1. Magnetic particles for water purification, comprising magnetic powder having a surface with which amphipathic groups are combined via metal atoms.

2. The magnetic particles according to claim 1, wherein said metal atom is selected from the group consisting of Zr, Al, Ti, Fe, Co, Ni, Cu and Zn.

3. The magnetic particles according to claim 1, wherein said amphipathic group comprises a hydrocarbon group and an acidic or basic residue.

4. The magnetic particles according to claim 3, wherein said amphipathic group is an acylate group.

5. The magnetic particles according to claim 1, wherein said organometallic compound is a metal acylate compound represented by the following formula (1):
(RO)ₘM(OCOR′)ₙ (1)
in which
M is a metal element selected from the group consisting of Zr, Al, Ti, Fe, Co, Ni, Cu and Zn;
each of m and n is independently an integer of 1 or more provided that the number of m+n corresponds to the valence of M;
R is an organic group containing 1 to 8 carbon atoms, and in the case of m is two or more, the plural groups of R may be the same or different from each other; and
R′ is a hydrocarbon group containing 1 to 30 carbon atoms, and in the case of n is two or more, the plural groups of R′ may be the same or different from each other.

6. The magnetic particles according to claim 1, wherein said magnetic powder consists of granules having a mean granule size of 0.2 μm to 5 mm.

7. The magnetic particles according to claim 1, wherein said magnetic powder is granulated from fine magnetic substance grains combined with a binder.

8. The magnetic particles according to claim 7, wherein said fine magnetic substance grains have a mean grain size of 0.05 μm to 100 μm.

9. Magnetic particles for water purification, prepared by subjecting magnetic powder to surface treatment with an organometallic compound comprising a metal atom connected to an alkoxy group and an amphipathic organic group.

10. A preparation process of magnetic particles for water purification, wherein an organometallic compound comprising a metal atom connected to an alkoxy group and an amphipathic organic group is mixed with magnetic powder and then stirred so that the magnetic powder is subjected to surface treatment.

11. The process according to claim 10, wherein said organometallic compound is liquid at room temperature.

12. The process according to claim 10, wherein said organometallic compound is dropped into or sprayed onto said magnetic powder under stirring and then subjected to heating treatment.

13. A water treatment composition comprising the magnetic particles for water purification according to claim 1.

14. A water treatment method comprising the steps of:
dispersing the magnetic particles according to claim 1 in water containing impurities, so that said impurities are adsorbed on the surfaces of said magnetic particles, and then
collecting and recovering the magnetic particles having adsorbed the impurities by use of magnetic force.

15. The method according to claim 14, wherein the collected and recovered magnetic particles are washed with at least one organic solvent selected from the group consisting of methanol, ethanol, n-propanol, iso-propanol, acetone, tetrahydrofuran, n-hexane, cyclohexane, and mixtures thereof, so that the adsorbed impurities are released to reclaim the particles.
